(19) United States
(12) Patent Application Publication
(10) Pub. No.: US 2026/0298814 A1
(43) Pub. Date: Oct. 1, 2026

(54) SYSTEMS AND METHODS FOR CALIBRATING EMISSIONS MONITORING EQUIPMENT

(71) Applicant: Cemtek Environmental, Inc., Santa Ana, CA (US)

(72) Inventors: Bertrand Lanher, San Jose, CA (US); Tyron Smith, Santa Ana, CA (US); Keith Crabbe, San Juan Capistrano, CA (US); Gary Cacciatore, Orange, CA (US)

(73) Assignee: Cemtek Environmental, Inc., Santa Ana, CA (US)

(21) Appl. No.: 19/630,330

(22) Filed: Mar. 26, 2026

Related U.S. Application Data
(60) Provisional application No. 63/778,141, filed on Mar. 26, 2025.

(51) Int. Cl. G01N 21/3504; G01N 21/33; G01N 21/85

(52) U.S. Cl. CPC G01N 21/3504; G01N 21/33; G01N 21/85; G01N 2201/06113; G01N 2201/08; G01N 2201/127

(57) ABSTRACT

In non-limiting examples of the present disclosure, IP-CEMS-compliant systems and methods for in situ monitoring, measuring, analyzing, and predicting emissions output from emission sources are presented. In preferred implementations, UV-DOAS and TDLAS systems generally comprise a light source, one or more optical elements, two optical transmission windows on opposite sides of a flue stack, a folded-path multi-pass calibration gas cell containing a calibration gas through which a light beam from the light source propagates within the cell via multiple reflections from internal mirrors, a detector for receiving a transmitted optical signal from the emissions stack or calibration gas cell, an analyzer and/or spectrometer for measuring one or more properties of a target gas from the flue stack, wherein the effective pathlength of the calibration gas cell is substantially equal to the stack pathlength.

### RELATED APPLICATION(S)

The present application claims the benefit of and priority to a U.S. Provisional Patent Application Ser. No. 63/778,141, filed Mar. 26, 2025, which is hereby incorporated by reference in its entirety into the present application.

### BACKGROUND

Continuous emissions monitoring is required by the Environmental Protection Agency (EPA). The regulations set forth in Title 40 of the Code of Federal Regulations (40 CFR), parts 60 and 75, describe continuous emission monitoring requirements, including detailed specifications for the layout and optical path requirements for Integrated Path Continuous Emission Monitoring Systems (IP-CEMS) during daily calibration process.

Traditional hot/wet extractive Continuous Emission Monitoring Systems (CEMS) carry and condition the flue gas sample from the stack to the analyzer on the ground, with all the sampling errors, maintenance, and operational costs associated with them. In contrast, an IP-CEMS measures the gas emissions from a stack in situ and transports the signal transmitted from the stack by means of fiber optics, with the analyzer positioned on the ground for ease of access and maintenance. The use of fiber optics and co-axial cables simplifies multiplexing of the measurements.

Systems and methods disclosed herein address, among other things, the requirements for initial and ongoing quality assurance and quality control activities using compressed specialty gases as transfer standards. In particular, the present disclosure enables the use of IP-CEMS relying on Tunable Diode Laser Absorption Spectroscopy (TDLAS) and Ultra-Violet Differential Optical Absorption Spectroscopy (UV-DOAS) for the measurement of pollutant gases in stationary emission sources in accordance with 40 CFR Part 75. IP-CEMS applications that involve the use of broadband UV light source (UV-DOAS) can be used to measure various gases such as NO, NO2, SO2, NH3, Cl2, CS2, HCHO, and BTX (benzene, toluene, xylenes) using the same hardware. TDLAS, on the other hand, can be used for analyzing gases such as NH3, CO, CO2, O2, HCl, H2S, CH4, H2O, HF, NO, NO2, N2O, and SO2 using narrowband, near-infrared (near-IR) and mid-infrared (mid-IR) light sources.

### FIELD OF THE INVENTION

The present disclosure generally relates to air quality management and more particularly to methods and systems for monitoring, measuring, analyzing, and predicting emissions output from emission sources more accurately than prior art, with specific focus on the use of IP-CEMS for emissions measurement and reporting within the scope of the EPA regulation 40 CFR Part 75.

### PROBLEM(S) SOLVED

The novel approach of the present disclosure addresses a previously unmet reporting requirement under 40 CFR Part 75 for IP-CEMS applications, which mandates initial and ongoing quality assurance and quality control activities using compressed specialty gases as transfer standards. These gases must have concentration values traceable to the National Institute of Standards and Technology (NIST) and be used to calibrate and verify analyzer response. The gas cylinders, supplied by a qualified specialty gas distributor, must also meet the EPA Protocol Gas Verification Program requirements. Quality assurance and control activities that employ these gases are evaluated using regulatory equations and specific cylinder data. Results of the calibration error test, including the upscale calibration target value, corresponding measured response, calculated upscale calibration error, and other required parameters, are reported in the fixed electronic format specified by the EPA.

Systems and methods for calibrating emissions monitoring equipment, as disclosed herein, allows the IP-CEMS to use the required EPA protocol gases to evaluate analyzer response quality, apply the regulatory equations, assess control limits, and report results using a certified Data Acquisition and Handling System (DAHS) in the EPA-prescribed electronic format.

### SUMMARY

The present disclosure is directed to systems and methods for calibrating emissions monitoring equipment, substantially as shown in and/or described in connection with at least one of the figures, as set forth more completely in the claims.

Under both 40 CFR Parts 60 and 75, detailed specifications for the layout and requirements of the optical path for IP-CEMS during daily calibration process are governed primarily by two performance specifications. IP-CEMS specifications may fall under these guidelines, requiring calibration checks to ensure accuracy over the full length of the optical path in the duct or stack.

Performance Specification 18 (PS-18) under 40 CFR Part 60 specifically addresses the calibration of optical paths in IP-CEMS. This includes ensuring that the calibration cell or gas interface passes along the entire pathlength used for emissions measurements to account for any potential interference or drift in measurement results. Daily calibration requirements generally specify that the entire sampling system, including the optical path, must be validated to ensure that the measurements are accurate across the full span of the IP-CEMS path.

Under 40 CFR Part 75, the fixed electronic format prescribed by the EPA Administrator states that the concentration of calibration gas injected into the path be numerically equal to the allowable gas concentration required for daily quality assurance as calculated from the emissions permit assigned to the emissions source. Compliance with this requirement can only be achieved through matching of the optical pathlength of the in-line calibration gas cell with the optical pathlength across the stack. Several technical and material constraints have prevented this requirement from being met in IP-CEMS applications governed by 40 CFR Part 75.

But unlike conventional IP-CEMS, the present disclosure provides a field-proven, Parts 60 and 75 compliant system and process that provide the same benefits as IP-CEMS while avoiding its limitations. Specifically, the present disclosure provides the following advantages: (a) high accuracy and sensitivity; (b) compact, easy-to-install, and easy-to-operate configurations or architectures; (c) allows use of tunable diode laser technology with a 10-year-or-more life span; (d) minimal consumable parts and maintenance; (e) reduced power requirements and calibration gas usage; and (e) very low operating costs.

### BRIEF DESCRIPTION OF THE DRAWINGS

FIG. 1 illustrates a conventional implementation of an IP-CEMS-compliant architecture.

FIG. 2 shows a cross-section of a flue stack monitored using a conventional CEMS.

FIG. 3 illustrates the optical path of a Herriott Cell multi-pass gas cell.

FIG. 4 shows a diagram of the optical path of a White Cell multi-pass gas cell.

FIG. 5 illustrates a conventional IP-CEMS configuration using at least one calibration spool for introducing calibration gases into the optical path of the IP-CEMS.

FIG. 6A illustrates an IP-CEMS with a straight-through, single-pass, fixed-length calibration gas cell having a pathlength equal to the stack pathlength.

FIG. 6B shows a diagram of an IP-CEMS including a folded-path, multi-pass calibration gas cell within which light undergoes multiple internal reflections.

FIG. 7 shows a diagram of a novel UV-DOAS system in accordance with the present disclosure.

FIG. 8 illustrates an exemplary TDLAS system for calibrating emissions monitoring equipment according to the present disclosure.

FIG. 9 illustrates another exemplary diagram of an IP-CEMS, Part 75-compliant, BLL-based TDLAS system configured for calibrating emissions-monitoring equipment.

FIG. 10A shows the reference and sample emission (power) spectra and the resulting transmission spectra typically obtained using broadband-source UV-DOAS.

FIG. 10B shows the emission spectra obtained using two different narrowband tunable diode lasers.

FIG. 11 is a flowchart of a method for dynamically adjusting measurements to account for differences between the optical pathlengths of a fixed-path calibration gas cell and the stack.

FIG. 12 shows an exemplary diagram of a free-space, transfer-optics output portion of a calibration gas cell in accordance with the present disclosure.

FIG. 13 presents a table and corresponding plots illustrating the material-dependent total energy throughput of a UV-DOAS calibration gas cell at the analytically critical wavelength of 226 nm.

FIG. 14 presents three reflectance spectra comparing measurements obtained using prior art and the present disclosure, each showing percent reflectance as a function of wavelength.

FIG. 15 is a flowchart of an exemplary method for calibrating emissions-monitoring equipment.

FIG. 16 illustrates an implementation of a multi-pass calibration gas cell comprising fiber optic input and output ports.

FIG. 17 shows a deep-UV fiber-coupled input-output sub-assembly for use with the UV-DOAS spectrometer of the present disclosure.

### DETAILED DESCRIPTION

The following description contains specific information pertaining to various systems and methods in accordance with the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

IP-CEMS refers to systems that continuously measure gas emissions directly within the process. In other words, IP-CEMS refers to systems that continuously measure the gas concentrations in situ. By contrast, traditional CEMS extract the flue gas from the stack or process and transport it to an instrument housing to be analyzed. Thus, the flue gas measurements may be performed either in situ or via extractive sampling from the process.

All IP-CEMS include: (a) a light source; (b) means to inject the light emitted by the source into and across the stack; (c) means for obtaining spectra resulting from absorption of the source light by gas molecules in the stack at certain wavelengths; (d) means for chemically analyzing (i.e., identifying one or more gases and determining, from the spectra, the concentration of the one or more gases in the stack at the time of measurement; and (e) calibration gas cell positioned in the source-to-detector light path, including the light path through the stack.

IP-CEMS offers various benefits from an economic, regulatory, operational and lifecycle-management standpoint compared to conventional CEMS. By sampling across the full width of the stack, IP-CEMS averages out gas concentration stratifications and provides more representative emission measurements. It also enables improved emission control and eliminates sample conditioning and transport-related errors because no sampling lines are used. Also, the system uses only fiber optic and coaxial cables for transporting signals. Further, IP-CEMS mitigates response delays and avoids adsorption/desorption losses associated with sample transport because it transmits signals solely through fiber-optic and coaxial cables.

IP-CEMS can also be more cost-effective than direct CEMS, especially for facilities in which installation and maintenance of direct monitoring equipment is impractical or prohibitively expensive. Operational cost savings over a 10-year period can be as high as 80%. Additionally, IP-CEMS provides flexibility by enabling the monitoring of multiple pollutants within a single framework, thus reducing the need for multiple direct-measurement devices. It also allows the use of fewer high-failure probability parts. Further, it reduces costs associated with service and maintenance labor, power usage, calibration gases, and consumable parts. With a cross-stack installation, an IP-CEMS eliminates all components that come into contact with the gas stack or gas sample, such as probes, sample lines, chillers, filters, pumps, and converters. Additionally, no components are placed in the process stream, eliminating corrosion issues associated with sample handling.

Detailed specifications for the layout and calibration of the optical path in IP-CEMS during daily operations are primarily governed by 40 CFR Part 60 performance specifications. Performance Specification 18 (PS-18) of Part 60 specifically addresses IP-CEMS optical-path calibration, requiring that the calibration gas cell or gas interface traverse the full pathlength used for emission measurements to account for potential interferences or drift. Calibration gas cells may take various forms, including internal sealed gas cells with automatic calibration modes, internal or external flow-through gas cells, external audit modules, and on-stack, in-path calibration spools.

Under Part 75, most fixed stacks and ducts have cross-duct lengths ranging from approximately 2 to 6 meters. Current IP-CEMS designs often employ calibration gas cells with shorter pathlengths than the stack pathlength, necessitating higher-concentration calibration gases. PS-18 (Part 60, Appendix B, Sect. 12.4.1, Equation 4) allows correction for these pathlength differentials when calculating target concentrations.

Although, in principle, a variable-pathlength gas cell could match the stack or duct pathlength, such configurations are generally impractical due to limited ruggedness, higher cost, complex opto-mechanical designs, and limited suitability for in-line integration in IP-CEMS. Thus, fixed-path calibration gas cells with optical pathlengths comparable to typical stack lengths are usually employed, with appropriate calculations applied to compensate for differences between the calibration cell and the stack. Daily calibration procedures and related calculations are described in PS-18, paragraph 12.0.

Specifically, calculations and data analysis under Sect. 12.4 deals with a three-step calculation of the measurement error (ME) or calibration drift (CD) for an IP-CEMS that uses a calibration cell. The calculation involves the following three steps:

1. Calculate target concentration, C_{i,eff}, corrected for temperature and pathlength differential between the gas cell and the stack (Sect. 12.4.1.; Eq. 4):

$${C}_{i , eff} = {C}_{i} \times \frac{{PL}_{cell}}{{PL}_{stack}} \times \frac{{T}_{stack}}{{T}_{cell}} \times LSF \qquad ( Eq . 4 )$$

where C_{i,eff}=equivalent concentration
Cᵢ=reference gas concentration used for test i
PL_{cell}=pathlength of IP-CEMS calibration cell
PL_{stack}=pathlength of IP-CEMS stack optical path
T_{cell}=gas temperature of the calibration gas cell
T_{stack}=temperature of the stack at the monitoring location for IP-CEMS
LSF=line strength factor for IP-CEMS instrument specific correction for temperature
and gas matrix effects derived from the HITRAN and/or manufacturer specific database

2. Calculate the average (stack) native concentration before and after each calibration check measurement (Sect. 12.4.2; Eq. 5)

$${MN}_{bi} = ( {MN}_{i} + {MN}_{i + 1} ) / 2 \qquad ( Eq . 5 )$$

where MN_{bi}=measured native concentration bracketing each calibration check measurement
MNᵢ=measured native concentration before calibration gas spike injection
MNᵢ₊₁=measured native concentration after calibration gas spike injection

3. Calculate the measurement error (ME) or calibration drift (CD) according to Sect. 12.4.3; Eq. 6A or 6B:

$${ME}_{IP} = {\sum }_{1}^{3} [ \vert ( {MC}_{i} - {MN}_{bi} ) - {C}_{i . eff} \vert / 3 S ] \times 100 \qquad ( Eq . 6 A )$$

$${CD}_{IP} = [ \vert {MC}_{i} - {MN}_{bi} - {C}_{i . eff} \vert / S ] \times 100 \qquad ( Eq . 6 B )$$

where ME_{IP}=measurement error for IP-CEMS (percent of span)
CD_{IP}=calibration drift for IP-CEMS (percent of span)
MCᵢ=averaged measured gas reference concentration i
MN_{bi}=measured native concentration bracketing each calibration check measurement
C_{i,eff}=equivalent concentration of the reference gas value, Cᵢ, at the specified conditions
Cᵢ=the certified (known) concentration of the calibration gas introduced at the i-th calibration point (Ci is a reference value, not a measured value)

Unlike Part 60, Part 75 does not offer pathlength differential compensation provisions. Appendix A, Section 6.3.1, of Part 75 discusses calibration requirements and states that for in situ monitoring, Equation A-5 below of Appendix A of Part 75 is used to determine the calibration error (CE) for a calibration gas as a percentage of the instrument span during daily or 7-day CE tests.

$$CE = ( \vert R - A \vert / S ) \times 100 \qquad ( Eq . A - 5 )$$

where CE=calibration error as a percentage of the instrument's span
R=reference value of zero or upscale (high-end to mid-level, as applicable) calibration gas introduced into the monitoring system
A=actual monitoring system response to the calibration gas
S=span of the instrument (difference between upper and lower range)

Achieving compliance with Part 75 requirements can be accomplished either using the relationship between apparent concentration and pressure based on the Ideal Gas Law, or using the relationship between apparent concentration and pathlength based on Beer-Lambert law. If based on the relationship between apparent concentration, pressure, and pathlength, a shorter calibration cell, which is both desirable and economically favorable, can be achieved by increasing the pressure of the calibration gas within the cell thus increasing the apparent gas concentration. This, however, raises safety concerns associated with the use of pressurized gases and introduces additional spectrometry modeling complexity (e.g., pressure-induced absorption-band broadening), thereby increasing the algorithmic load required to calculate calibration results.

If based on the inverse relationship between apparent concentration and pathlength under isobaric and isothermal conditions, a cost-effective calibration cell can be realized by folding the optical path within a physically shorter cell while maintaining an effective pathlength substantially equal to the stack pathlength. This compact configuration also reduces the cell's dead volume and avoids the safety concerns associated with gas pressurization, as well as the more complex modeling required by approaches that rely on the proportional relationship between apparent concentration, pressure, and pathlength. Furthermore, for a fixed temperature and number of moles of gas, the IGL implies that pressure is inversely proportional to volume; in a geometry with a fixed cross section, this relationship can be interpreted as an inverse relationship with pathlength. Accordingly, an IGL-based approach maintains a constant apparent calibration gas concentration by increasing gas pressure when a shorter calibration-cell pathlength is used. In practical terms, the elevated pressure allows the use of a calibration gas whose concentration is equal to the EPA-defined Monitoring Span Value (MSV).

However, short calibration-gas-cell pathlengths operated at high pressures to meet EPA-defined MSV numerical input requirements raise safety concerns associated with pressurized gases and introduce additional algorithmic complexity. Consequently, IGL-based approaches impose additional mechanical and safety requirements related to gas pressurization. They also typically require more complex correction algorithms and may introduce greater uncertainty in the resulting concentration calculations.

In a Part 75-compliant, IGL-based IP-CEMS solution, the absorption spectrum of a sample gas is compared with that of a reference gas. A fitting algorithm analyzes the center wavelengths, heights, and widths of the respective absorption bands to determine the concentration of the target gas. For a valid 40 CFR Part 75 application, the fixed electronic format prescribed by the EPA Administrator requires that the concentration of the calibration gas injected into the optical path be numerically equal to the allowable gas concentration required for daily quality assurance, as calculated from the emissions permit assigned to the source. Thus, during the Emissions Collection and Monitoring Plan System (ECMPS) evaluation of the Electronic Data Report (EDR), daily calibration results will trigger a critical error if gas cylinders concentrations exceed the required percentage of the MSV (defined as a percentage of the analyzer span). This means that if the span for NOₓ, for example, is 10 ppmv and the calibration gas concentration is 9 ppmv, a 9-ppmv NOx EPA-certified cylinder must be used for the application to be Part 75-compliant.

To utilize an IP-CEMS for Part 75 applications, calibration gas cylinders must contain gas concentrations numerically equal to the following MSV defined in Section 5.2 of 40 CFR Part 75, Appendix A:
Zero-Level 0.0 to 20.0 percent of span
Low-Level 20.0 to 30.0 percent of span
Mid-Level 50.0 to 60.0 percent of span
High-Level 80.0 to 100.0 percent of span

While variable-length calibration gas cells could theoretically match a wide range of stack dimensions, such designs are impractical for field deployment due to mechanical complexity, cost, and limited ruggedness. Current IP-CEMS implementations therefore rely on fixed-path-length calibration cells combined with analytical correction methods or BLL-based path-matching solutions suitable for regulated Part 75 applications.

When using a BLL-based IP-CEMS solution, the calibration gas cell pathlength is matched to that of the stack: l_{cell}=l_{stack}, where the gas cell pressure approximates the stack pressure (P_{cell}~P_{stack}). This enables the injection of a calibration gas at a concentration numerically equal to that of the EPA-defined MSV without resorting to sample pressurization. A BLL-based solution also provides the following advantages: (a) allows operation at nearly identical pressures for both the stack and gas cell but with a smaller form factor and using less calibration gas than the equivalent full-length calibration gas cell; (b) enables practical, smaller volume multi-pass gas cell; (c) improves power throughput, signal-to-noise ratio (SNR), sensitivity, and precision; (d) removes the need for calibration gas pressurization and associated issues (mechanical, safety and increased algorithmic requirements and associated errors); and (e) satisfies the accuracy, sensitivity, and stability requirements for the daily and 7-day drifts allowable under 40 CFR Parts 60 and Part 75.

In addition, a BLL-based IP-CEMS solution meets the requirements of equation A-5 in Part 75, Appendix A, Section 6.3.1, when using either UV-DOAS or TDLAS. In-house testing verified the accuracy, sensitivity, and stability of both IP-CEMS techniques. When using a BLL-based solution, the calibration gas cell pathlength must be sufficient to satisfy SNR and 7-day drift requirements. In particular, 40 CFR 60, Appendix B, requires a 7-day drift check in addition to a one-time calibration drift test, for certain pollutants.

A 7-day drift test verifies that the IP-CEMS calibration remains within allowable limits over seven consecutive days of normal operation, thereby demonstrating the system's stability and reliability. Other typical IP-CEMS quality assurance requirements include: (1) daily calibration checks; (2) quarterly to annual Cylinder Gas Audits (CGA), including linearity; (3) Annual Relative Accuracy Test Audit (RATA); and (4) some additional gas-specific tests including, but not limited to, opacity and interference checks as may be required by regulations.

Various aspect or implementations of the present disclosure include one or more of the following elements: (a) dimensioning near ideal theoretical optical path models; (b) use of wedged input and output windows; (c) internal black anodizing of calibration gas cell walls with optical coating having less than 11% reflectivity; (d) internal sandblasting to create an anechoic optical activity; (e) manual application of velvet metal caches on the edges of the field mirrors to further reduce back reflection interferences (etalons); (f) optical telescope prescriptions allowing near-parallel collimation; (g) variable aperture for removal of straight light injections into the stack (coupled with telescope prescriptions, minimum aperture yields no measurable power loss); (h) linear actuator with micrometric screw control for measured and reproducible focus setting; (i) simplified stack injection optics using a flat mirror (divergence set using the micrometric telescope); (j) mirror surface with reflectivity selected to minimize power loss; (k) flat mirrors selected for significantly reduced power loss; and (l) extractive pneumatic design with two input gas ports placed on the edges (Z-axis) of the gas cell and one output extractive gas port placed on the opposite side of the gas cell. The calibration gas cell is connected to a downstream extractive pump with a response time of less than 2 minutes.

The use of shorter effective focal length mirrors in the calibration gas cell, together with higher-reflectivity optical coatings, enables a multi-pass gas cell design with a greater number of passes to achieve the same effective pathlength. This configuration reduces the cell's internal dead volume, thereby improving pneumatic response time and reducing calibration gas consumption. Additionally, certain mirror configurations reduce dead volume, while smaller calibration gas cell volumes minimize both calibration gas consumption and calibration time.

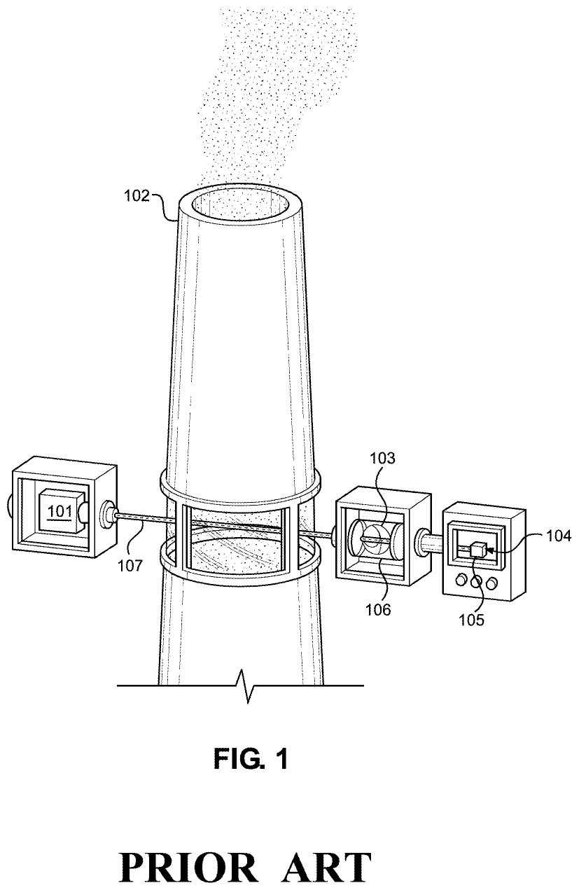

FIG. 1 illustrates a conventional implementation of an IP-CEMS-compliant architecture 100. In this implementation, the system 100 is configured to sample flue gas across the full width of the stack 102. A light beam 107 emitted by the light source 101 propagates across the entire length of the flue stack 102. The light beam 107 exiting the stack 102 is collected by the receiving optics 103 and subsequently traverses the entire length of the calibration gas cell 106. Upon exiting the calibration cell 106, the light beam 107 is received by the detector 105 and then communicated to the analyzer 104, where the corresponding optical signal is processed and analyzed. The prior art system 100 shown in FIG. 1 provides several advantages, including improved representativity of actual emissions, enhanced emission control, and averaging of gas stratification within the stack 102.

For UV-DOAS applications based on IP-CEMS, which employ a broadband UV light source, the UV light beam exiting the calibration gas cell is directed into a spectrometer. Within the spectrometer, the receiving optics-typically comprising collimating optics and a dispersive element such as a diffraction grating-spatially separate the attenuated broadband optical signal into its constituent wavelengths. The spectrally dispersed light is then incident on a detector, such as a CCD or photodiode array, where wavelength-resolved intensity is measured and subsequently processed by an analyzer.

In contrast, for IP-CEMS-based TDLAS applications, which employ a narrowband, tunable diode laser as the light source, the emitted laser beam (e.g., near-IR or mid-IR laser beam) is directed through the calibration gas cell and across the flue stack. Rather than being dispersed by a spectrometer, the wavelength of the laser is scanned across a selected absorption transition (i.e., absorption band) of the target gas. In some implementations, the laser output may also be modulated using a high-frequency waveform. The transmitted optical signal, attenuated by absorption along the optical path, is collected by the receiving optics and directed onto a photodetector, which measures intensity as a function of time corresponding to the wavelength sweep. The resulting signal is processed by an analyzer, wherein wavelength-resolved absorbance is reconstructed and fitted using spectroscopic parameters to determine the concentration of the target gas, optionally using harmonic components of the modulated signal.

Also, an IP-CEMS differs from a conventional extractive CEMS primarily in how the gas is measured within the stack. In an IP-CEMS, an optical beam is transmitted directly across the flue stack, enabling measurement of gas concentration over an extended optical path and thereby providing a path-averaged value representative of the entire cross-section. In contrast, a conventional CEMS extracts a gas sample from a single point within the stack and transports it through a sample conditioning system to an analyzer, where the concentration is measured under controlled conditions. As a result, IP-CEMS avoids potential sampling and conditioning artifacts and offers more spatially representative measurements, whereas conventional CEMS relies on point sampling and requires careful handling of the extracted gas to maintain measurement accuracy.

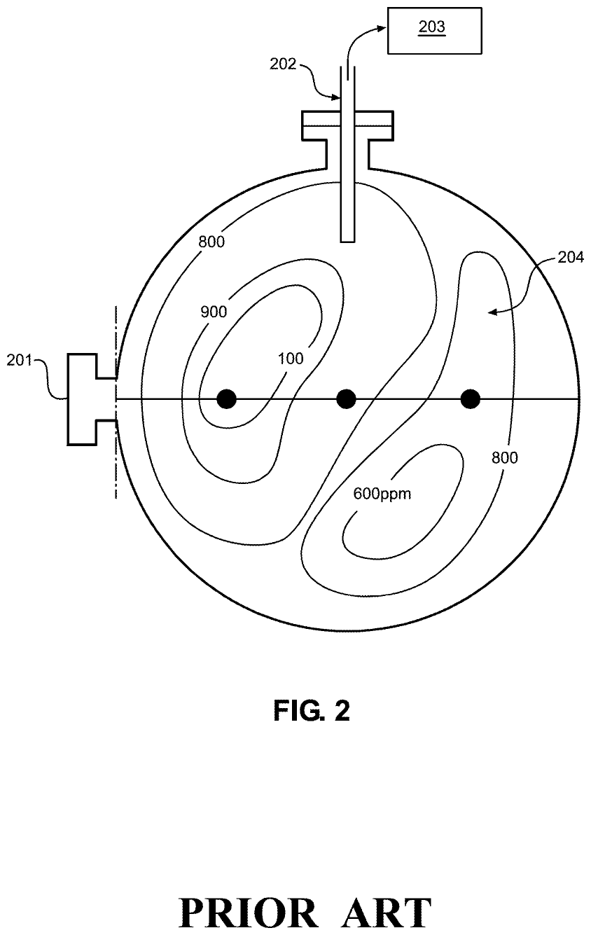

FIG. 2 shows a cross-section of a stack monitored using a conventional CEMS 203, with gas concentration (shown in ppm) inhomogeneities 204 across the stack due to gas stratification. Gas concentration inhomogeneities or stratification 204 can lead to inaccurate measurements of emissions at any given time when a single sampling point extractive CEMS analyzer is used. By contrast, IP-CEMS-compliant systems measure the average concentration of a gas across the stack, thus providing a more representative measure of the overall concentration of a gas measured within the stack flue gas. Here, the EPA Reference Method (RM) test port 201 is used for reference method validation (e.g., Relative Accuracy Test Audit (RATA)) of the CEMS 203. Specifically, a gas sample is extracted for analysis through this port 201. The measurements may be used, for example, to calculate a reference concentration average for compliance verification as required by EPA regulations and to benchmark the installed CEMS during RATA. A probe 202 is used to extract flue gas 204 samples and send the extracted gas to the CEMS analyzer 203 for measurement.

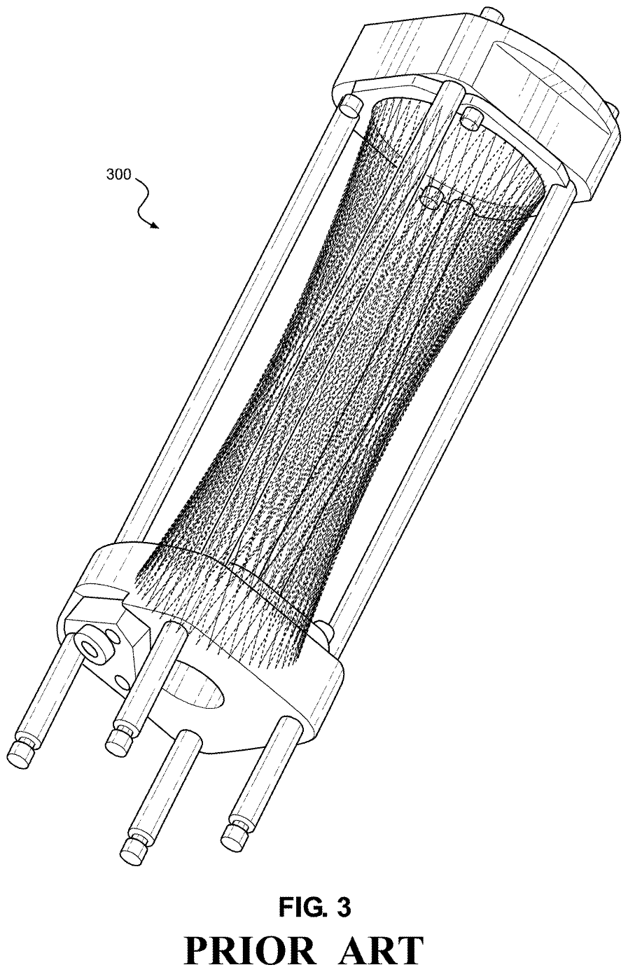

FIG. 3 illustrates the optical path of a light beam in a Herriott Cell multi-pass gas cell 300. Herriott gas cells are not used in current IP-CEMS. Instead, they are typically used in extractive gas analyzers, e.g., for extractive CEMS integrations. Although a Herriott gas cell design was previously considered as a design path toward a Part 75-compliant IPCEMS, it was eventually rejected for two reasons: (1) complexity of light beam shaping prior to injection into the gas cell, especially for UV-DOAS broadband source applications; and (2) larger dead volumes (which are undesirable in terms of calibration gas consumption and cost) than those in a White gas cell design.

In particular, the use of a Herriott-design multi-pass gas cell with appropriate output beam shaping—even if it provides an equivalent optical pathlength and is limited by the numerical aperture (NA) of the fiber optics used (typically NA=0.22 and NA=0.50 for UV-DOAS and TDLAS applications, respectively)—would result in a gas cell having a larger dead volume and, consequently, an undesirable longer pneumatic response time or higher associated EPA-certified calibration gas usage and cost.

When a collimated IR beam enters the cell through the entrance aperture, it reflects between the two mirrors in a predictable pattern. Each reflection traverses the gas, effectively multiplying the single-pass pathlength. After a predefined number of reflections, determined by mirror spacing and beam injection angle, the beam exits through the same or through a secondary aperture. By folding the beam path, Herriott cells can achieve effective pathlengths of tens to hundreds of meters in a cell that is physically only a few centimeters to tens of centimeters long. While the Herriott design is preferred for achieving long optical paths, it typically requires two large-diameter mirrors, resulting in a larger dead volume and, for a given gas flow rate, an increased pneumatic response time.

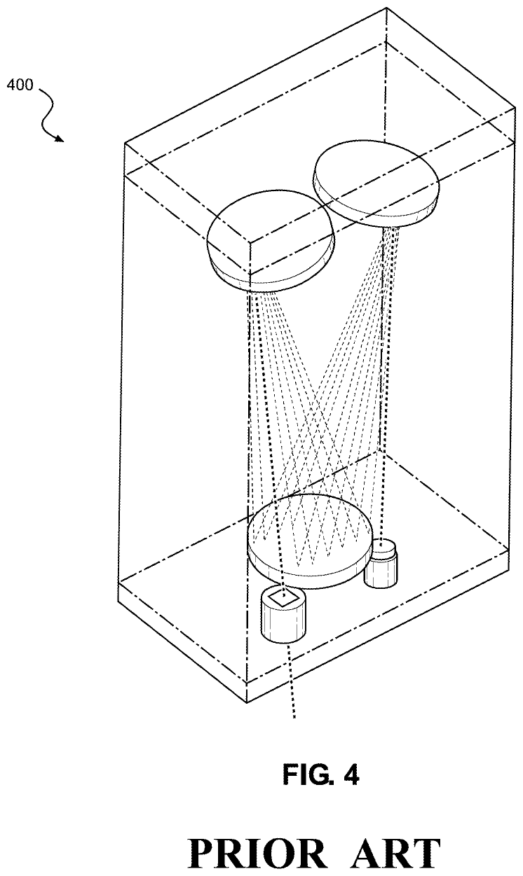

FIG. 4 illustrates an optical path of a light beam in a White multi-pass calibration gas cell 400. Preferred embodiments of the present disclosure are directed to the use of White multi-pass calibration cells 400. Like other multi-pass designs, a White cell increases the effective optical pathlength through a gas sample, thereby enhancing sensitivity to low-concentration species such as CO, CO₂, NOx, SO₂, and other gases. White multi-pass calibration cells are commonly used for extractive spectrometry-based gas analyzers (extractive CEMS), but they are generally not used for IP-CEMS applications.

A White cell comprises: (a) three spherical mirrors arranged in a specific geometric configuration; (b) an entrance/exit port through which a collimated light beam enters and ultimately exits the cell; and (c) a sample gas volume between the mirrors that the light beam traverses multiple times. The primary goal of a White cell is to fold the optical path so the light beam is able to travel a longer distance within a relatively compact physical volume. The White cell comprises three mirrors, one larger than the other two. One of the two smaller mirrors receives the incoming light beam that enters the White cell's input port located on the opposite side of the cell. After the beam undergoes multiple reflections within the cell, the other of the two smaller mirrors reflects the light beam towards the cell's output port. A third mirror on the opposite side of the calibration cell, which is typically larger than the other two mirrors, redirects the beam across the cell volume towards the two smaller mirrors to allow for multiple internal beam reflections within the cell. By carefully adjusting the relative positions and curvature of the three mirrors, the beam forms a stable spot pattern, often lying in a plane or near-planar bundle. The effective pathlength can be tens to hundreds of meters even if the physical cell has dimensions on the order of centimeters to decimeters.

In an IP-CEMS analyzer using a White cell, a broadband source (e.g., a UV lamp) or a narrowband tunable laser (e.g., a tunable diode laser) produces radiation that spans wavelengths appropriate for the target gas species. In this implementation, a light beam from a light source is collimated, enters the White cell, undergoes multiple reflections off the three internal mirrors, and thereby traverses the gas sample multiple times. After exiting the calibration cell, the now-attenuated light is detected by one or more photodetectors optimized for specific wavelengths. The measured absorbance is processed using Beer-Lambert law to compute the concentration of the target gas species. This multi-pass configuration boosts the cumulative absorbance signal, which improves detection limits compared to single-pass calibration cells.

For both TDLAS and UV-DOAS applications, a White cell-based optical design is preferable because: (a) it enables the use of smaller-diameter field mirrors; and (b) it relies on the use of only the narrow central portion of the larger main mirror, thus enabling truncating the optically unused upper and lower portions of the mirror. The combination of these two elements allows the reduction of the internal dead volume of the gas cell which, for the same given gas input flow rate, yields a shorter pneumatic response time. An additional benefit of the White-cell design with a truncated main mirror is reduced consumption of calibration gases, resulting in lower operational costs for the end user. Also, regulations require that the calibration gas cell be installed in line with the optical path extending from the light source to the detector and passing through the stack or duct in which the gases are measured.

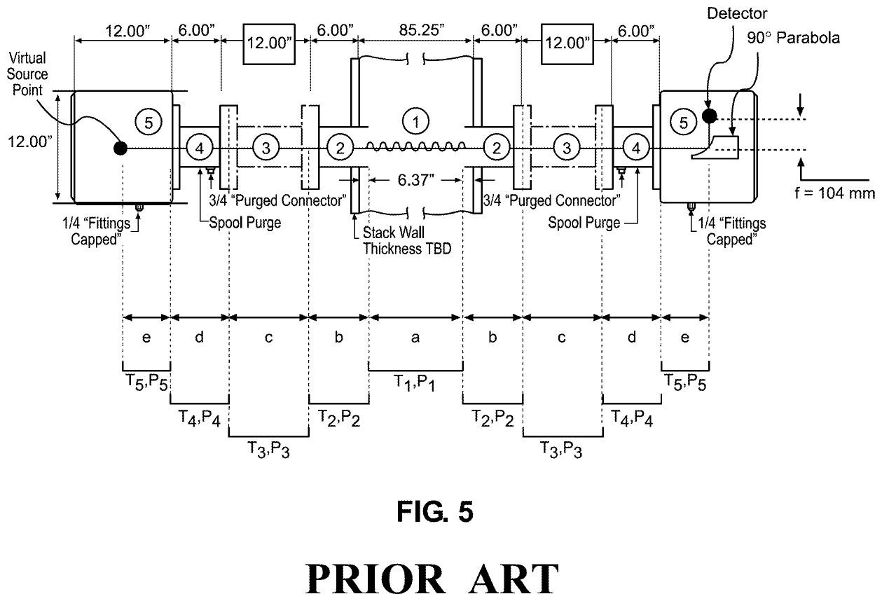

FIG. 5 illustrates a conventional IP-CEMS configuration using at least one of the two calibration spools 506, 507 to introduce calibration gases into the optical path of the IP-CEMS. In the configuration illustrated in FIG. 5, the stack 501 with length a contains flue gas at temperature T₁ and pressure P₁. The adjacent stack spools 502, 503 on both sides of the stack include flanges that enable connection of the IP-CEMS stack optics to the stack. Purge air is introduced into these spools 502, 503 to prevent infiltration of flue gas and to protect the optics from fouling by particulate matter or aerosols present in the stack. Each of the spools 502, 503 has a length b, and the purge gas within the spools 502, 503 is at temperature T₂ and pressure P₂.

Connecting spools 504, 505 include flanges that provide thermal protection for the IP-CEMS stack optics by spacing the optics from the stack spool/flange assembly by a distance c. The connecting spools 504, 505 are typically filled with purge air, instrument air, or dry nitrogen, depending on the application, and are maintained under positive pressure. The gas within these spools 504, 505 is at temperature T₃ and pressure P₃.

The calibration (purge) spools 506, 507 may be positioned on either side of the stack 501 along the optical path of the IP-CEMS, but only one of them is required. Each of the calibration spools 506, 507 has a length d and is filled with a calibration gas during calibration, and with instrument air or dry nitrogen during normal operation. The gas within the calibration spool is at temperature T₄ and pressure P₄.

In the launcher and detector optics boxes 508, 509, the pathlength followed by the light beam is equal to e and must be accounted for when measuring gases in the stack 501 that are also normally present in atmospheric air (e.g., O₂ or CO₂). Unless purged, the launcher and detector optics boxes 508, 509 are filled with atmospheric air at temperature T₅ and pressure P₅.

The calibration spool 506, 507 is characterized by a single-pass optical path. However, compliance with 40 CFR Part 75 using this design would only be met if the length of the calibration spool 506, 507 is numerically equal to the internal diameter a of the stack 501, where the internal diameter defines the optical pathlength. For the vast majority of stacks, which feature internal diameters (i.e., optical pathlengths) of several meters, this approach would be impractical at best. The present disclosure mitigates this physical impracticality by using a folded-path (multi-pass) gas cell as a calibration gas cell in place of a calibration spool.

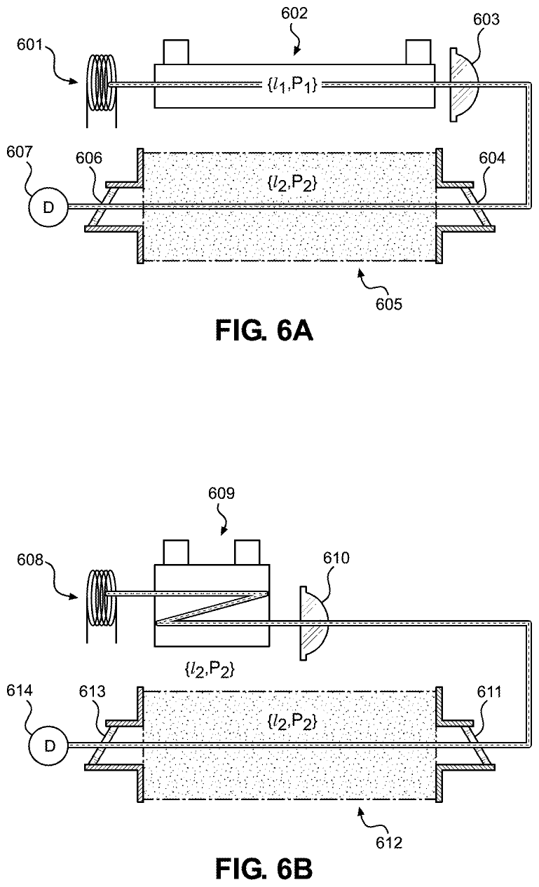

FIGS. 6A and 6B show a schematic of two different implementations of an IP-CEMS-based UV-DOAS application. FIG. 6A shows a UV light source 601 the emits a light beam that propagates through a straight-through, fixed-length calibration gas cell 602 with a pathlength equal to l₁ and pressure equal to P₁. The light beam that exits the calibration cell 602 is collected by a condenser lens 603 that directs the transmitted light beam towards the entrance window 604 of the flue stack 605 with a pathlength given by l₂ and a pressure equal to P₂. After traversing the entire length of the flue stack 605, the light beam exits through the exit window 606 of the flue stack 605 and finally reaches the detector 607.

For accurate gas measurement calibration, the optical pathlengths of the gas cell 602 and the flue stack 605 should ideally match. Identical pathlengths allow injection of a calibration gas at a concentration numerically equal to the EPA-defined monitoring span value (MSV) without requiring sample pressurization. However, it is advantageous to use shorter calibration gas cell pathlengths during continuous monitoring. As previously described, an IGL-based method permits the use of a shorter gas cell pathlength while maintaining an effective calibration gas concentration equal to the MSV by increasing the calibration gas pressure. In this approach, higher pressure compensates for a reduced cell pathlength relative to that of the stack.

With the exception of the straight-through fixed-length calibration cell 602 in FIG. 6A, all the other components in FIG. 6B are identical to those shown in FIG. 6A. FIG. 6B shows a UV light source 608 the emits a UV light beam that propagates through a folded-path calibration gas cell 609 with an effective pathlength equal to l₂ and pressure equal to P₂. The UV light beam that exits the folded-path calibration cell 609 is collected by a condenser lens 610 that directs the transmitted light beam towards the entrance window 611 of the flue stack 612 with a pathlength given by l₂ (which is substantially equal to the effective pathlength of the folded-path cell) and a pressure equal to P₂. After traversing the entire length l₂ of the flue stack 612, the UV light beam exits through the exit window 613 of the flue stack 612 and finally reaches the detector 614.

As shown in FIG. 6B, the folded-path gas cell is physically much shorter than the stack width but provides, through the use of mirrors, an effective optical pathlength equal to the flue stack pathlength, thereby permitting operation at nearly identical pressures P₂. This folded-path configuration allows reduction of the cell size and calibration gas consumption compared with a straight-through fixed-length calibration cell having a physical pathlength equal to that of the full stack. The compact multi-pass design of a folded-path cell improves optical throughput, sensitivity, and precision. Specifically, the folded-path implementation allows for fewer optical losses per pass, shorter mirror spacing (reducing beam footprint on mirrors), lower clipping, scattering, and diffraction losses, higher effective mirror reflectivity per round trip, fewer optical interfaces, and reduced beam divergence over the optical path. Compact cells also maintain the beam waist and overlap with the detector active area, typically require fewer windows, flanges, or purge volumes, and eliminate the need for calibration gas pressurization, thereby avoiding associated mechanical, safety, and algorithmic complexities and errors.

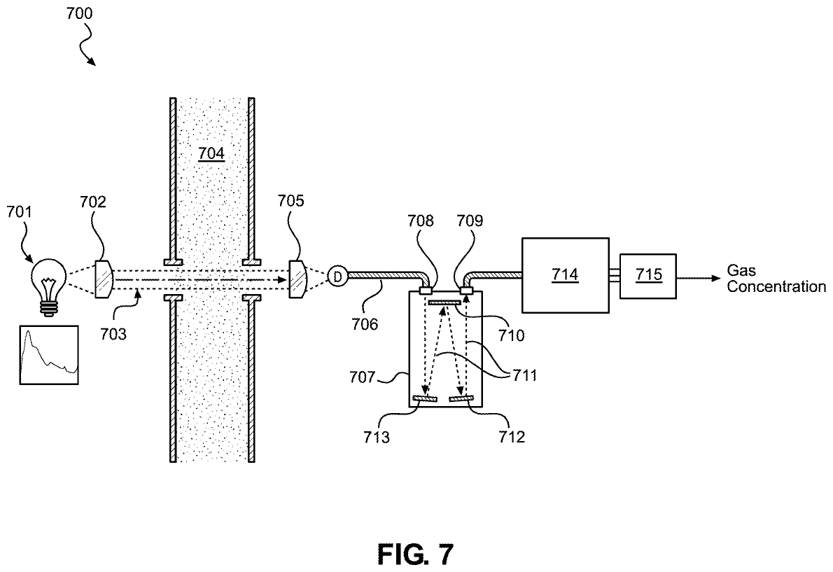

FIG. 7 shows a diagram of a novel UV-DOAS system 700 that includes a broadband UV light source 701 that emits a UV light beam toward a beam-shaping optical element, such as a collimating lens 702. The collimating lens 702 directs the collimated UV beam 703 into a first optical transmission window of an emissions stack 704. (In the present disclosure, the term “emissions stack” is used interchangeably with “flue stack” and “stack.”) The collimated UV beam 703 propagates across the diameter of the stack 704 and exits the stack 704 through a second optical transmission window on the opposite side of the stack 704. The collimated UV beam 703 then reaches a condenser lens 705, which focuses the UV beam 703 onto a fiber optic cable 706.

The UV beam propagating through the fiber optic cable 706 is introduced into the calibration gas cell 707 (based on a White-cell design), where it undergoes multiple internal reflections 711 off three mirrors 710, 712, 713 inside the calibration cell 707, which contains a calibration gas. After undergoing multiple internal reflections, the light beam 711 exits the calibration cell 707 through the fiber optic output port 709 of the calibration cell 707. At this point, the UV beam has interacted with one or more gases in the stack 704, as well as with the calibration gas inside the calibration cell 707.

After traversing the flow-through calibration gas cell 707, the UV light—having undergone sequential absorption in both the stack 704 and the calibration cell 707—is directed to the UV spectrometer 714 for spectral analysis, with data acquisition and processing performed by the CPU 716. Within the UV spectrometer 714, the incoming broadband UV beam passes through an entrance slit and is collimated before being spatially dispersed by a diffraction grating (or prism) into its constituent wavelengths, each exiting at a distinct angle. The spectrometer's focusing optics then map these angularly dispersed wavelengths onto corresponding spatial positions on the detector array. The detector generates signals proportional to the light intensity at each wavelength, thereby producing a full absorption spectrum. This measured spectrum reflects the combined absorbance contributions from both the flue gas in the stack 704 and the calibration gas in the calibration cell 707, enabling quantitative retrieval of the target species concentration based on the known calibration gas contribution.

During normal operation, dry zero air is introduced into the inlet of the calibration gas cell, resulting in negligible differential UV absorption within the UV-DOAS measurement window. When a calibration gas is introduced, its absorbance adds linearly to that of the same species, the target gas, present in the flue gas within the stack 704, in accordance with the Beer-Lambert law.

In UV-DOAS, the concentration of the target gas in the flue stack is determined by separating the target stack gas contribution from the combined signal of the stack gas and the calibration gas. Specifically, the UV-DOAS spectral fit yields a total slant column density corresponding to the sum of the stack and calibration gas contributions along the optical path. The slant column density represents the amount of gas integrated over the sum of the stack and the calibration gas cell pathlengths. The known slant column density of the calibration gas is then subtracted from the total slant column density to extract the portion attributable to the stack gas alone. The concentration of the target gas in the stack is then obtained by dividing this stack slant column density by the known optical pathlength of the stack.

The UV region of the electromagnetic spectrum (approximately 190-400 nm) provides a highly sensitive spectral domain for both qualitative and quantitative analysis of gases relevant to emissions-monitoring applications, including ammonia (NH₃), nitric oxide (NO), nitrogen dioxide (NO₂), and sulfur dioxide (SO₂). A significant technical challenge in implementing sensitive and accurate spectroscopic measurements in this spectral region is the limited availability of optical materials that simultaneously provide high reflectivity for mirrors and high transmissivity for lenses and windows. This limitation is particularly critical when monitoring NH₃, NO, and NO₂ using differential optical absorption spectroscopy (DOAS), because key absorption features for these species occur in the strongly attenuating deep-UV region spanning approximately 200-230 nm.

Conventional mirror coatings exhibit reduced reflectance in this wavelength range; for example, losses on the order of 20-25% per reflection are typical for standard coatings. These losses significantly limit the achievable number of passes in a multi-pass calibration gas cell, thereby constraining the effective optical pathlength and reducing measurement sensitivity due to cumulative power attenuation, which contributes to SNR and sensitivity degradation. SNR optimization is integral to the present disclosure for achieving the sensitivities required for IP-CEMS and for complying with Part 75 performance, QAP, and reporting requirements.

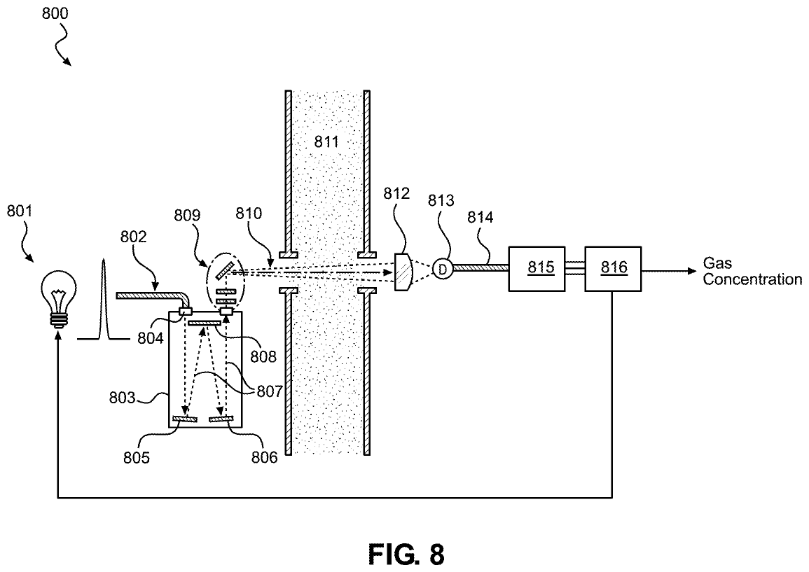

FIG. 8 illustrates an exemplary TDLAS system 800 for calibrating emissions monitoring equipment in accordance with the present disclosure. The system comprises a narrowband laser source 801, such as a near-infrared (NIR) laser. The NIR beam emitted by the NIR laser is coupled into a fiber optic cable 802, which is connected to an input port 804 of a calibration gas cell 803 based on a White-cell design. Within the calibration gas cell 803, the NIR beam undergoes multiple reflections from three internal mirrors 805, 806, 808. The NIR beam then exits the cell towards a free-space output optics assembly 809, and is directed toward a first stack light transmission window. The NIR beam enters the stack 811 and propagates across its diameter, during which the NIR beam interacts with the target gas. The beam then exits the stack 811 through a second transmission window and travels toward a condenser lens 812. The condenser lens 812 focuses the divergent IR beam onto a detector 813, which converts the incident optical signal into a photocurrent. The photocurrent is conditioned by a TDLAS control module (not shown), which synchronizes signal acquisition with modulation of the tunable diode laser source and outputs a corresponding electrical signal via a coaxial connection to the ADC 815 and CPU 816.

Under typical operations, dry zero air (low-moisture purified air, which is transparent to near-IR light and contains negligible amounts of the target gas used for calibration) is injected into the flow-through calibration gas cell 803 through the gas cell inlet. When a calibration gas is injected into the cell 803, the absorbance due to the absorption of certain wavelengths of light in the near-IR region by the calibration gas is added to the absorbance due to one or more gases in the stack.

The TDLAS system 800 shown in FIG. 8 provides several advantages, including matching the optical pathlengths of the stack and the calibration gas cell, improving optical throughput via free-space injection by reducing losses associated with fiber-optic interfaces, and eliminating the need for calibration gas pressurization. Eliminating pressurization reduces mechanical and safety constraints and avoids additional algorithmic complexity and associated sources of error.

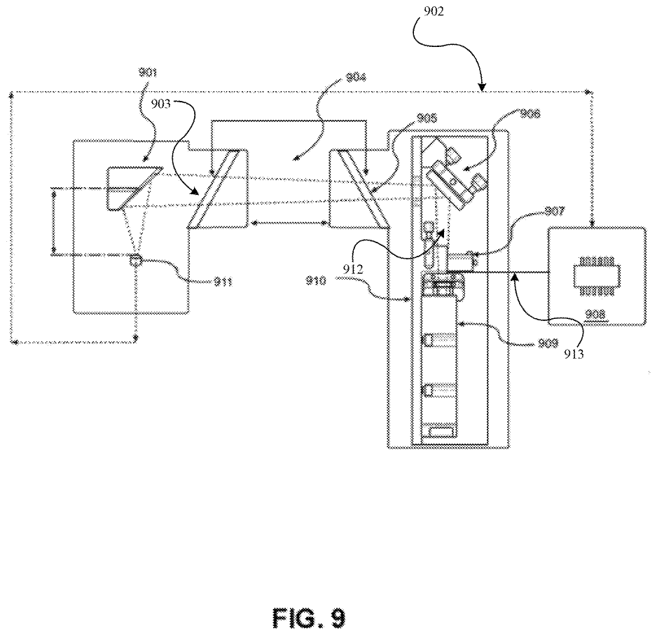

FIG. 9 illustrates another implementation of an IP-CEMS, Part 75-compliant, BLL-based TDLAS system configured for calibration of emissions-monitoring equipment. In this TDLAS configuration, the light source, such as a narrowband IR diode laser, is located inside a 19-inch rack-mounted analyzer compartment 908. The IR laser is coupled into a fiber optic cable 913, which is connected to an input port 910 of a calibration gas cell 909 based on a White-cell design. Within the calibration gas cell 909, the IR beam undergoes multiple reflections from three internal mirrors (not shown). The IR beam 912 then exits the calibration cell 909 via a free-space output optics assembly 907, and is directed by a 90°-deflecting or folding mirror 906 toward a first stack light transmission window 905. The IR beam 912 then enters the flue stack 904 and propagates across its diameter, during which the IR beam 912 interacts with the target gas. After undergoing absorption by the gases in the calibration gas cell 909 and the stack 904, the now-attenuated beam 912 then exits the stack 904 through a second transmission window 903 and travels toward a 90°-parabolic mirror (off-axis parabolic mirror) 901. The parabolic mirror 901 focuses the attenuated divergent IR beam 912 onto a detector 911, which converts the incident optical signal into a photocurrent. The photocurrent is conditioned by a TDLAS control module (not shown), which synchronizes signal acquisition with modulation of the tunable diode laser source and outputs a corresponding electrical signal via a coaxial cable 902 connected to the ADC and CPU located inside the 19-inch rack-mounted analyzer compartment 908.

The calibration cell subsystem can be installed directly on the stack, with the laser coupled into the stack via a free-space optical path. This arrangement enables the effective pathlength of the calibration gas cell to be matched to the optical pathlength across the stack and improves optical power throughput by avoiding losses associated with fiber-optic coupling and transmission. This configuration also eliminates the need to pressurize the calibration gas, thereby avoiding associated mechanical and safety constraints, as well as increased algorithmic complexity and potential sources of error. In addition, the system satisfies the requirements of Equation A-5 in Appendix A, Section 6.3.1 of 40 CFR Part 75.

In the particular implementation shown in FIG. 9, a critical design constraint arises from the use of a 6.5-μm (0.00025-in.) single-mode fiber optic cable in the TDLAS system. A fiber-in/fiber-out in-line calibration gas cell designed to maximize power throughput using an eight-pass, 4.0-m optical pathlength would require impractically stringent alignment, with angular tolerances on the order of less than 0.05°. To address this limitation, the present disclosure employs a fiber optic cable to deliver the emitted light from the light source to the calibration gas cell, followed by direct free-space light beam injection into the stack from the gas-cell output. In this configuration, the gas cell is installed in the IP-CEMS launcher box housing a 19-inch rack-mounted analyzer 907. This arrangement simplifies alignment and optimization of the laser beam across the stack by using a telescope mounted on a graduated linear translation stage for focusing, together with a two-screw pitch- and yaw-adjustable flat mirror that may be used in place of a parabolic mirror assembly.

In conventional designs, light exiting the gas cell is typically collected using a lens with a very short effective focal length (EFL) lens and refocused onto the input aperture of a single-mode fiber optic. However, as implemented in prior art, this approach introduces significant optical power losses, typically exceeding 40%, depending on the accuracy of the lens prescription and the fabrication tolerances achievable with current manufacturing techniques. In addition, the optical materials commonly used in these systems impose transmission limits that restrict practical operation to wavelengths of approximately 1700 nm or below, thereby precluding the use of this configuration for TDLAS measurements at longer wavelengths. More specifically, within the scope of gas-measurement applications regulated under 40 CFR Part 75, carbon monoxide (CO) cannot be measured using this optical configuration because a useful absorption band for TDLAS occurs near 2.33 μm, which lies outside the effective transmission range of the fiber-coupled optical design described above.

The present disclosure employs optically simple, readily reproducible, and cost-effective lens elements fabricated from materials that provide adequate transmission at wavelengths greater than 1700 nm, in combination with a free-space optical architecture utilizing high-reflectivity, low-loss mirrors. This configuration enables measurement of gases having absorption features above 1700 nm (for example, carbon monoxide) while also improving overall optical power transmission efficiency. In addition, the gas-cell output transfer optics are simplified to facilitate optical alignment, thereby reducing the level of training required for routine adjustment and maintenance by technical personnel who are not optical specialists.

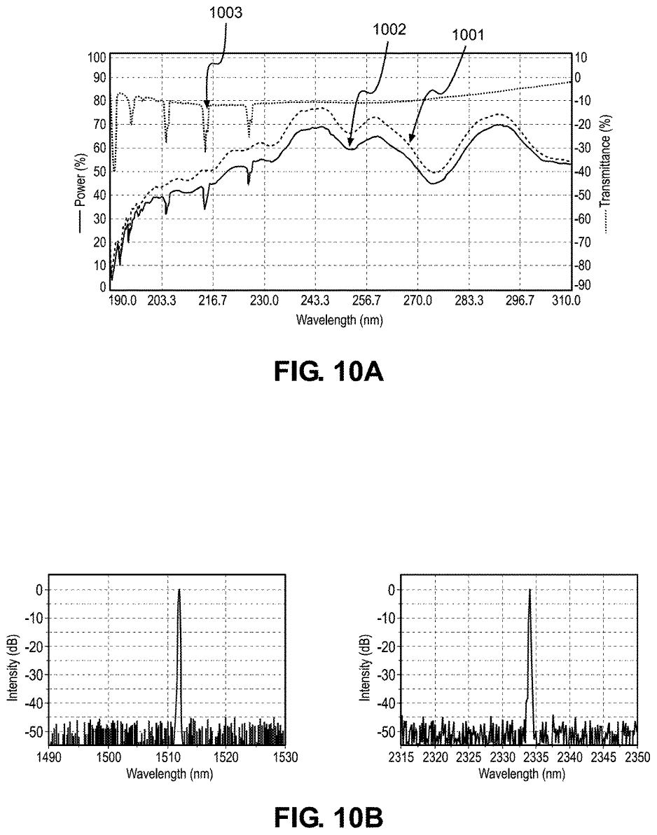

FIG. 10A shows a reference emission spectrum 1001, a sample emission spectrum 1002, and a resulting transmission spectrum 1003, as typically obtained using broadband-source UV-DOAS, wherein the collected spectral information spans a wide UV wavelength range. In FIG. 10A, the reference spectrum 1001 is measured in the absence of the absorbing sample and primarily reflects the spectral response of the lamp and optical components. The transmission spectrum 1003, which exhibits a substantially flatter baseline than the sample emission spectrum 1002, displays distinct absorption features at specific wavelengths. The transmission spectrum 1003 is derived from the sample emission spectrum 1002 and the reference spectrum 1001. FIG. 10B shows two emission spectra obtained using two different narrowband tunable diode lasers, each spectrum characterized by a narrow emission band at a wavelength corresponding to an absorption line of the target gas.

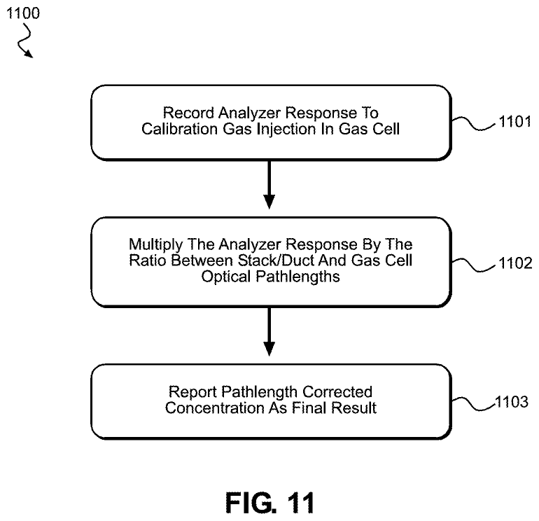

FIG. 11 presents a flowchart 1100 of a method for dynamically adjusting measurements to account for differences between the optical pathlengths of a fixed-path calibration gas cell and the stack. Step 1101 involves recording the analyzer response to calibration gas injection into the gas cell. In step 1102, the analyzer response is multiplied by the ratio between the stack and calibration gas cell optical pathlengths. Finally, in step 1103, the pathlength-corrected concentration is recorded. By using the ratio of the gas cell pathlength to the stack width, accurate calibration calculations can be performed without the need to vary the gas cell pathlength. For both TDLAS and UV-DOAS, the spectrometer's sensitivity and its associated SNR must be considered when defining the minimum gas cell optical pathlength required to meet regulatory requirements for accuracy and sensitivity. Additionally, the pneumatic response time of the system is a critical factor in IP-CEMS qualification, as regulations impose a maximum amount of time for successfully completing all CEMS analyzers' daily calibration checks under the stationary-source Quality Assurance Plan (QAP).

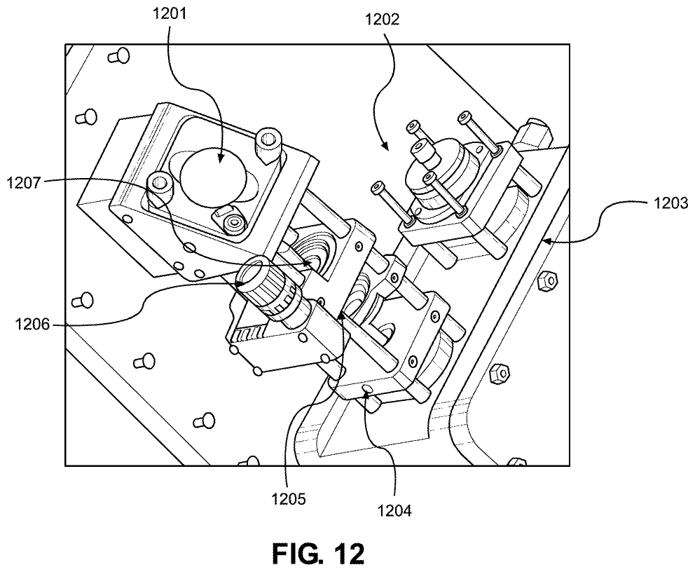

FIG. 12 shows an exemplary diagram of a free-space, transfer-optics output portion of the calibration gas cell according to one implementation of the present disclosure. As shown in FIG. 12, the free-space, transfer-optics output assembly comprises the following components: (a) 90°-flat mirror 1201 for beam injection into the stack; (b) 6-axis fiber port collimator 1202 for incident beam injection into an optical cavity; (c) wedged window 1203 to avoid collinearity of back reflections with the incident beam onto the mirrors; (d) telescope input lens 1204; (e) variable aperture 1205 for stray light removal or suppression; (f) linear stage with graduated micrometric focus adjustment 1206; and (g) telescope output lens 1207. The implementation shown in FIG. 12 relies on fiber-optic input and direct light injection into the stack from the calibration gas cell output, with the calibration gas cell located in the IP-CEMS launcher box. This design simplifies fine tuning of the laser alignment across the stack by using a telescope output lens 1207 mounted on a graduated linear stage 1206 for focusing and a two-screw pitch/yaw-controlled flat mirror 1201 that replaces the parabolic mirror assembly.

The 6-axis fiber port collimator 1202 includes X-axis, Y-axis, and Z-θ adjustment mechanisms that provide precision control, enabling refinement from coarse alignment to high-efficiency, low-loss optical coupling. Specifically, the Z-θ adjustment mechanism provides precise axial positioning of the fiber tip or collimating lens, thereby controlling beam collimation and coupling efficiency into downstream optics. The transfer-optics assembly further includes wedged windows that disrupt collinearity between back-reflections and the incident beam at the mirrors, thereby suppressing optical interference.

A traditional opto-mechanical design relies on fiber-optic input/output with appropriately collimated fiber port interfaces. This approach is used in preferred UV-DOAS implementations of the present disclosure. However, in the TDLAS version of the IP-CEMS, the limiting factor is the small core diameter of single-mode fiber optics, typically 6-9 μm. Although it is possible to align the output fiber to capture light propagated through the gas cell after multiple reflections from the main and field mirrors, doing so requires extremely tight optical tolerances. Such alignment demands specialized technical expertise and is impractical for field realignment, particularly when access is limited to non-specialist personnel. For instance, to properly couple light into a 6.5 μm diameter output fiber after eight reflections using 500 mm effective focal length (EFL) mirrors, the maximum allowable angular misalignment is only 0.05°. Achieving this level of precision is challenging, even under controlled laboratory conditions, and requires specialized tools and experience.

To overcome these limitations, preferred TDLAS implementations use a standard fiber port collimated input but incorporates an original free-space optical design at the output. This design optimizes the shape of the beam exiting the calibration gas cell for maximum power throughput, thereby improving the SNR while maintaining photometric performance. As a result, the system meets the accuracy and sensitivity requirements of 40 CFR Part 75 for low gas concentration applications.

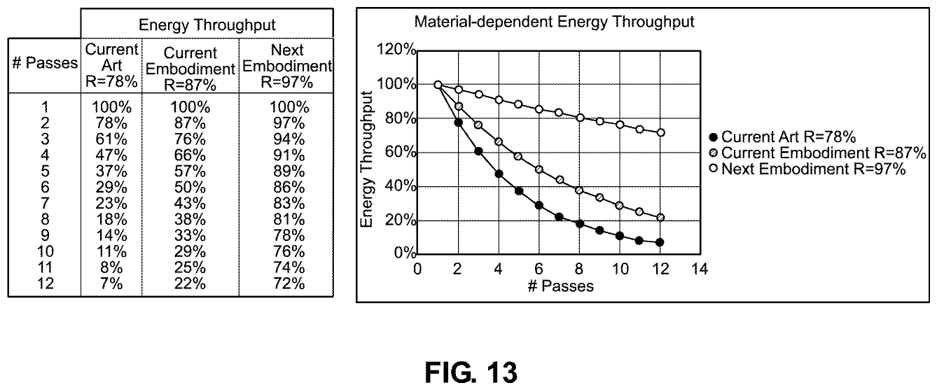

FIG. 13 presents a table and corresponding plots illustrating the material-dependent total energy throughput of a UV-DOAS calibration gas cell at the analytically critical wavelength of 226 nm. This configuration employs different mirror reflective coatings. Energy throughput—also referred to as optical throughput, transmission efficiency, or optical efficiency—represents the fraction of optical power that successfully propagates through the entire calibration gas cell and reaches the detector. As shown in FIG. 13, mirror coatings used in prior-art configurations 1301 yielded a maximum total energy throughput of approximately 78%. The associated losses (on the order of 22% per reflection) limit the number of passes that can be practically achieved in a multi-pass calibration gas cell due to cumulative attenuation.

By contrast, two reflective materials utilized in the present disclosure 1302, 1303 produced substantially higher total energy throughputs of approximately 87% and 97%, respectively. Expressed in terms of cumulative loss, the results presented in FIG. 13 indicate that the BLL-based IP-CEMS configuration of the present disclosure can reduce total energy loss to approximately 13% and as low as about 3%, depending on the number of passes and the selected coating. These results demonstrate that a BLL-based IP-CEMS architecture enables substantially enhanced optical power throughput through the use of very high-reflectivity mirror materials. This improvement makes it feasible to employ a practical, small-volume multi-pass calibration gas cell for deep-ultraviolet (DUV) applications. The configuration also eliminates the need for calibration gas pressurization, thereby avoiding associated mechanical and safety constraints as well as increased algorithmic complexity and potential sources of error. In addition, the system satisfies the requirements of Equation A-5 in Appendix A, Section 6.3.1 of 40 CFR Part 75.

The new-generation mirrors used in the present disclosure incorporate novel reflective coatings that outperform prior-art coatings in terms of reflectance and overall optical throughput. These coatings offset optical losses, which are particularly severe in the UV region, thereby permitting compliance with Part 75 performance requirements. The resulting enhancement in transmitted energy after multiple passes—necessary to achieve the equivalent of meter-scale optical pathlengths required for this application—is substantial. For example, after eight passes in the current implementation, the energy throughput using prior-art mirror coatings was approximately 18% of the initial optical power injected into the gas cell. In contrast, using newly available mirrors with reflectance values of R=87% and R=97%, the energy throughput after eight passes increases to approximately 38% and 81% of the injected optical power, respectively.

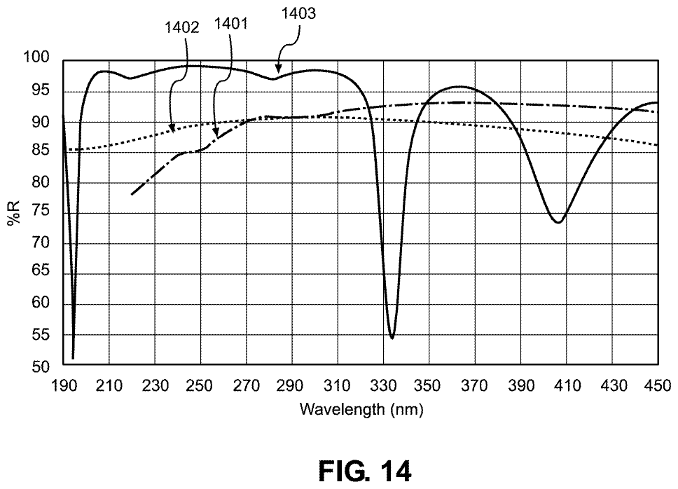

FIG. 14 presents three reflectance spectra comparing measurements obtained using prior art and the present disclosure, each showing percent reflectance as a function of wavelength. The first curve 1401, representing prior art, shows that low-reflectance optical coatings limit the achievable number of passes in a multi-pass gas cell, thereby constraining the total effective optical pathlength. The second curve 1402, measured in accordance with the present disclosure, indicates that a reflectance of approximately 87% enables up to eight passes while remaining compliant with 40 CFR Part 75. The third curve 1403, also measured in accordance with the present disclosure, shows that mirror coatings with reflectance greater than 97% in the deep UV region between 200-230 nm are associated with increased attenuation near 195, 334, and 406 nm. These wavelengths lie outside the critical analytical region used for Part 75-compliant gas measurements.

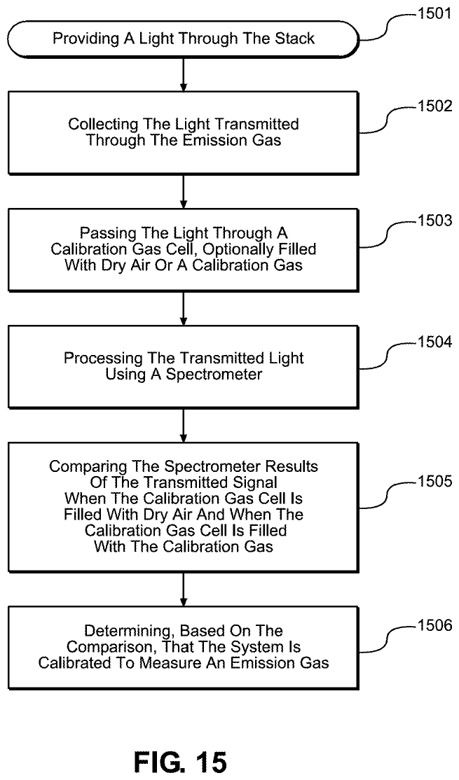

FIG. 15 is a flowchart of an exemplary method 1500 for calibrating emissions-monitoring equipment, in accordance with one implementation of the present disclosure. The method begins at step 1501, where a light source directs an optical beam through the stack, the stack containing the emission gas to be measured. At step 1502, the system collects light transmitted through the emission gas. The method then proceeds to step 1503, where the transmitted light is directed through a calibration gas cell positioned downstream of the stack. In alternative implementations, the optical path is configured such that the light passes through the calibration gas cell prior to traversing the stack; in such configurations, the method may begin at step 1503, followed by steps 1501 and 1502.

During normal operation, the calibration gas cell is filled with dry zero air. During calibration, the calibration gas cell is instead filled with a gas of known concentration to provide a reference for calibration. At step 1504, the collected light is analyzed by a spectrometer to determine one or more characteristics of the optical signal. At step 1505, the system compares the spectroscopically processed signal obtained during normal operation with that obtained during calibration. At step 1506, the system determines a calibration state based on the comparison of the measured characteristics of the operational signal and the calibration signal.

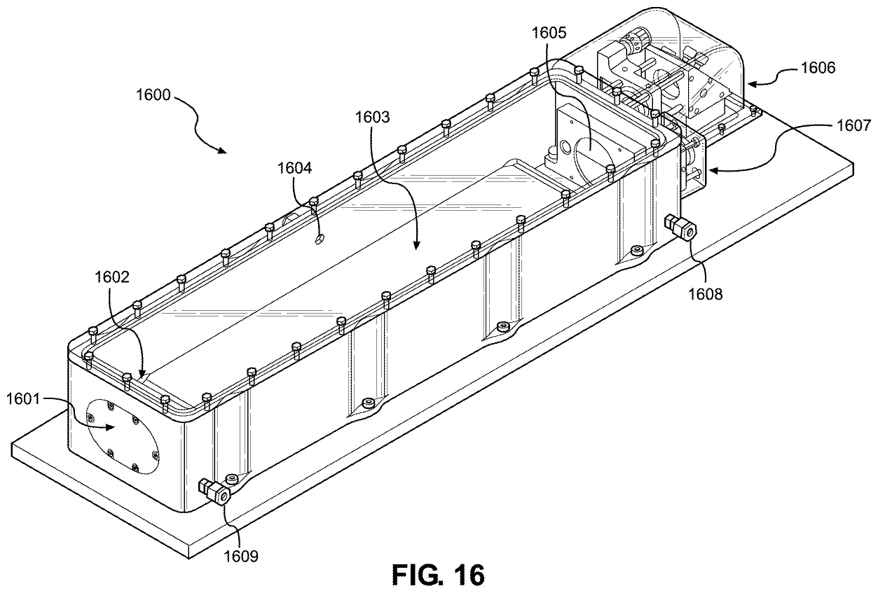

FIG. 16 illustrates a multi-pass calibration gas cell 1600 in accordance with the present disclosure. Optically, the gas cell comprises an adjustable fiber optic input assembly 1607, an output free-space transfer optics assembly 1606 for injection of the light beam into the flue stack, two field mirrors on the opposite side 1602 of the cell's fiber optic input 1607 and output 1606 ports, and a main mirror 1605 facing the two field mirrors on the opposite side of the cell. The internal mirrors inside the calibration gas cell 1600 may be field mirrors, objective mirrors, or their combination.

Pneumatically, the gas cell comprises an input filter 1603 to prevent particulate matter contamination of optical elements inside the gas cell, two calibration gas input ports 1608, 1609, and one calibration gas output port 1604 to maximizes purge efficiency time of the gas cell, therefore maximizing the response time of the analyzer to calibration gas and dry nitrogen flushing gas injections. The primary design constraint is the optical spot size (i.e., the mode-field image) produced at the output of the input fiber optic, which injects light into the gas cell. In one implementation, the fiber optic is a single-mode fiber having a core diameter of approximately 6.5 μm and a numerical aperture of approximately 0.23.

Optical modeling performed without physical dimensional constraints indicates that an optimal configuration comprises an 8-12-pass gas cell with an effective single-pass length of approximately 400 mm. As used herein, “single-pass length” refers to the physical propagation distance of the beam between successive reflections along a single traversal. In this configuration, the resulting spot size on the field mirrors is approximately 12.7 mm.

Considering the availability of off-the-shelf components and cost-effective manufacturability, a similar form factor may be employed for a UV-DOAS Part 75 gas cell using an eight-pass configuration with an approximately 500 mm single-pass length and field mirrors having an outer diameter of approximately 25.4 mm. In production implementations, the gas cell volume may be reduced by a factor of approximately 2-3 relative to the modeled configuration.

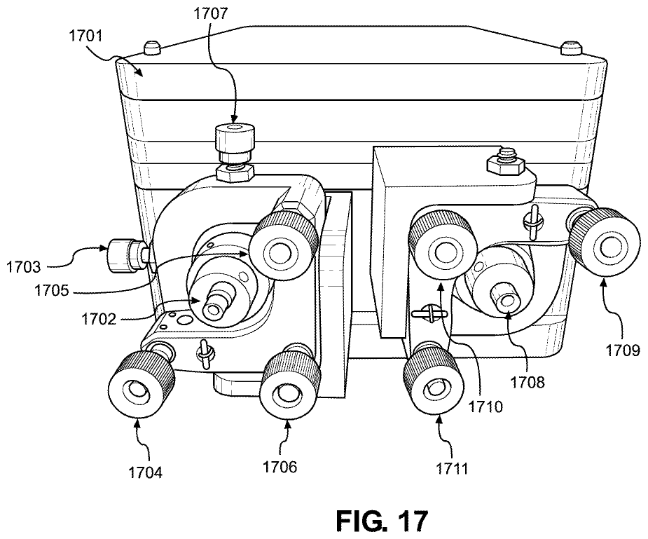

FIG. 17 shows the optical interface of the fiber-coupled input/output embodiment of the deep-UV (DUV) configuration for use with the UV-DOAS spectrometer of the present disclosure. In the implementation shown in FIG. 17, one end of an external calibration gas cell 1701 is connected to a DUV fiber optic input sub-assembly (left side of the figure) and to a DUV fiber optic output sub-assembly (right side of the figure). The fiber optic input sub-assembly comprises a fiber optic input connector 1702 (an SMA905 connector, as shown in FIG. 17) and three adjustment knobs 1704, 1705, 1706 to provide X-, Y-, and Z-axis positioning control and two smaller knobs 1703, 1707 for focus control. The positioning and focus controls are used for optimizing the alignment of the incident DUV light beam entering the folded-path, multi-pass gas cell 1701.

Similarly, the DUV calibration gas cell fiber optic output sub-assembly includes a fiber optic output connector 1708 (also an SMA905 connector, as shown in FIG. 18). In addition, the fiber optic output sub-assembly comprises three adjustment knobs 1709, 1710, 1711 to provide X-, Y-, and Z-axis positioning control for optimizing the alignment of the outgoing DUV light beam exiting the folded-path, multi-pass gas cell 1701.

In accordance with the present disclosure, a gas emission stream is analyzed to determine the concentration of one or more constituent gases, including at least one of benzene, toluene, ethylbenzene, and xylenes (BTX); chlorine (Cl₂); methane (CH₄); carbon monoxide (CO); carbon dioxide (CO₂); carbon disulfide (CS₂); formaldehyde (HCHO); hydrogen chloride (HCl); hydrogen cyanide (HCN); hydrogen fluoride (HF); water vapor (H₂O); hydrogen sulfide (H₂S); ammonia (NH₃); nitric oxide (NO); nitrogen dioxide (NO₂); oxygen (O₂); and sulfur dioxide (SO₂).

In some implementations, the light sources used for calibrating emissions-monitoring equipment may include mid-IR, near-IR, visible, or UV light sources, including broadband UV light sources. In certain implementations, the light source may comprise a narrowband tunable diode laser, inter-cascade laser, quantum cascade laser, or another narrowband source. In alternative implementations, the light source may comprise a broadband emitter, such as a Globar (silicon carbide) source for mid-IR emission.

The emission gas to be measured may include ammonia (NH₃), nitric oxide (NO), nitrogen dioxide (NO₂), and sulfur dioxide (SO₂). In some implementations, the system may be configured to measure additional emissions or pollutants. In a preferred configuration, the calibration gas cell comprises a multi-pass gas cell, which enables deployment of calibration systems at or near the stack (e.g., on-stack or on-site) without requiring a full-scale calibration chamber that replicates the dimensions of the emission stack.

In a preferred implementation, an IP-CEMS-based system for analyzing gas emissions comprises a light source, a plurality of optical elements, a first emissions-stack window disposed on a first side of an emissions stack, and a second emissions-stack window disposed on an opposing side of the emissions stack. The system further comprises a multi-pass calibration gas cell containing a calibration gas, wherein a beam from the light source propagates multiple times within the calibration gas cell between a first cell window and a second cell window.

The system also comprises a detector configured to receive a transmitted optical signal emerging from at least one of the flue stack or the calibration gas cell, and an analyzer comprising a spectrometer configured to measure one or more properties of gas within the emissions stack, the analyzer being operatively coupled to a computing device. The system is configured such that the optical measurement spans substantially the entire cross-sectional pathlength of the emissions stack.

The concentration of the calibration gas flowing through the calibration gas cell is selected to correspond to, or approximate, a monitoring span value without requiring calibration gas pressurization. In TDLAS-based applications, an input fiber optic associated with the calibration gas cell is optically coupled to an output free-space injection optical assembly disposed on the first side of the emissions stack. In such configurations, the light-source beam is delivered via the fiber optic into the gas cell and is injected into the emissions stack from the free space calibration gas cell output.

In one aspect, the optical signal received by the detector corresponds to transmitted radiation following propagation of an incident beam from the light source through at least one of the emissions stack and the calibration gas cell. The light source may comprise a UV or IR light source. For implementations based on differential optical absorption spectroscopy (DOAS), the light source preferably comprises a broadband UV source. For implementations based on tunable diode laser absorption spectroscopy (TDLAS), the light source preferably comprises a narrowband source, such as a diode laser operated in the infrared region.

In one aspect, a single scanning laser may be configured to measure one or more gas species (e.g., one or two gases per scan). In another aspect, multiple tunable diode lasers may be employed, each selected for detection of a respective target gas. The light source or scanned wavelength range is selected to coincide with spectral regions in which the target gas exhibits strong absorption features, thereby improving sensitivity and selectivity.

In a preferred embodiment, an IP-CEMS system comprises: (a) a light source; (b) a plurality of optical elements; (c) a first emissions-stack window disposed on a first side of an emissions stack; (d) a second emissions-stack window disposed on an opposing side of the emissions stack; (e) a multi-pass calibration gas cell containing a calibration gas, the calibration gas cell being configured to receive a beam from the light source that propagates multiple times between a first cell window and a second cell window; (f) a detector configured to receive transmitted optical radiation emerging from at least one of the emissions stack or the calibration gas cell; and (g) an analyzer comprising a spectrometer configured to measure one or more properties of gas within the emissions stack, the analyzer being operatively coupled to a computing device.

The system is configured such that the optical measurement spans substantially the entire cross-sectional pathlength of the emissions stack. The concentration of the calibration gas flowing through the calibration gas cell is selected to correspond to, or approximate, a monitoring span value without requiring calibration gas pressurization. An output fiber optic associated with the calibration gas cell is optically coupled to a free-space injection optical assembly disposed on the first side of the emissions stack. In such configurations, the light-source beam is delivered via the fiber optic and injected into the emissions stack from the calibration gas cell output.

In one aspect of the invention, the optical signal received by the detector corresponds to transmitted radiation following propagation of an incident beam from the light source through the stack or the calibration gas cell. The light source is preferably self-referencing to provide intrinsic span stability. The system may comprise one or more light sources operating at different wavelengths.

In certain implementations, optical alignment is fine-tuned using a telescope mounted on a linear translation stage in combination with a pitch-yaw-adjustable flat mirror. In a highly preferred implementation, optical path calibration for continuous emissions monitoring complies with Performance Specifications 2 and 18 under 40 CFR Part 60. In one implementation, the optical pathlength across the emissions stack is matched to the effective optical pathlength of the calibration gas cell. Preferably, the calibration gas cell pathlength is determined dynamically.

In another implementation of the invention, a system for in situ analysis of gas emissions comprises: a light source; a plurality of optical elements; a first emissions-stack window disposed on a first side of an emissions stack; a second emissions-stack window disposed on an opposing side of the emissions stack; a multi-pass calibration gas cell containing a calibration gas, the calibration gas cell being configured to receive a beam from the light source that propagates multiple times between a first cell window and a second cell window; and an analyzer module comprising a spectrometer and a processor, the analyzer module being operatively coupled to a computing device. In a preferred implementation, the gas within the emissions stack is sampled across substantially the entire cross-stack optical path (i.e., the stack diameter). The concentration of the calibration gas flowing through the calibration gas cell is selected to correspond to, or approximate, a monitoring span value without requiring calibration gas pressurization.

In the above-described implementation, the system further comprises an output fiber optic associated with the calibration gas cell that is optically coupled to a free-space injection optical assembly disposed on the first side of the emissions stack. The light beam is delivered via the fiber optic and injected into the emissions stack from the calibration gas cell output. Optical alignment may be fine-tuned using a telescope mounted on a linear translation stage in combination with a pitch-yaw-adjustable flat mirror. The calibration gas cell may be positioned within a launcher box of the system.

In another embodiment, a system for in situ analysis of gas emissions comprises: (a) a broadband ultraviolet (UV) light source; (b) a first optical element configured to collimate the emitted radiation into a collimated UV beam; (c) a first emissions-stack window disposed on a first side of an emissions stack through which the collimated UV beam enters the stack; and (d) a second emissions-stack window disposed on an opposing side of the emissions stack through which the collimated UV beam exits the stack. A second optical element is configured to collect and focus the transmitted UV radiation into a fiber optic coupled to a flow-through, multi-pass calibration gas cell, wherein one or more gas species within the emissions stack and the calibration gas cell absorb the UV radiation.

The total absorbance measured by the system corresponds to the combined absorbance of the calibration gas within the calibration gas cell and the process gases within the emissions stack. The UV radiation exiting the calibration gas cell is directed to a UV spectrometer for analysis.

In a further implementation, a system for in situ analysis of gas emissions comprises: (a) a light source disposed within a rack-mounted analyzer; (b) a fiber optic coupled to a flow-through, multi-pass, White-type calibration gas cell; and (c) a free-space injection optical assembly disposed on a first side of an emissions stack, the free-space injection optical assembly being optically coupled to an output fiber optic from the calibration gas cell. The radiation exiting the calibration gas cell is delivered via the output fiber optic and injected across the emissions stack.

An optical element disposed on a second side of the emissions stack collects radiation transmitted through the stack and directs the collected radiation to a detector. The detector provides an analog signal to the rack-mounted analyzer for digitization and processing. The measured absorbance corresponds to the combined absorbance of the calibration gas within the calibration gas cell and one or more gas species within the emissions stack.

The system of the present disclosure preferably comprises a fiber-port collimation input assembly based on a free-space optical design, configured to condition the beam exiting the calibration gas cell to optimize beam quality, optical throughput, and SNR. In preferred implementations, the photometric performance satisfies the accuracy and sensitivity requirements specified under 40 CFR Part 75 for low gas concentration measurements. During zero calibration, dry zero air may be introduced into the flow-through calibration gas cell to establish a baseline (zero-absorption) spectrum.

The present disclosure is also directed to a method for analyzing gas emissions in situ, wherein at least one gas within the emissions stack is sampled across the entire length of the stack. The method comprises directing a light beam from a light source to a first light transmission window located on a first side of an emissions stack. A flow-through gas-cell input fiber optic is connected to a free-space injection optical assembly located on the first side of the emissions stack. The light beam propagates across the entire length of the emissions stack and exits through a second light transmission window located on a second side of the emissions stack. The light beam is then focused into a multi-pass calibration gas cell containing a calibration gas. A concentration of the calibration gas flowing through the calibration gas cell is configured to be close to or equal to a monitoring span value. Within the cell, the light beam propagates multiple times across a path length between a first window and a second window of the calibration gas cell. As the light beam exits the stack or the calibration gas cell, the transmitted optical signal from either the emissions stack or the calibration gas cell is received by a detector. The detector is coupled to a spectrometer configured to measure one or more properties of at least one gas within the emissions stack. In various implementations, the spectrometer forms part of an analyzer that is coupled to a computing device.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system for analyzing gas emissions in situ comprising:
a light source,
a plurality of optical elements,
a first light transmission window on a first side of an emissions stack,
a second light transmission window on a second side of the emissions stack,
a multi-pass calibration gas cell containing a calibration gas through which a light source beam from the light source propagates multiple times across a length spanned by a first calibration gas cell window and a second calibration gas cell window,
a detector for receiving a transmitted optical signal from the emissions stack or calibration gas cell,
an analyzer comprising a spectrometer for measuring one or more properties of at least one gas from the emissions stack, wherein the analyzer is coupled to a computing device,
wherein
the at least one gas from the emissions stack is sampled across an entire length of the emissions stack,
a concentration of the calibration gas that flows through the calibration gas cell is configured to be close or equal to a monitoring span value, and
a flow-through, gas-cell input fiber optic is connected to a free-space injection optical assembly located on the first side of the emissions stack.

2. The system of claim 1, wherein the light source beam is directly injected via a fiber optic input into the emissions stack from a calibration gas-cell output.

3. The system of claim 1, wherein an emissions stack pathlength is equal to an effective calibration gas-cell pathlength.

4. The system of claim 1, wherein the concentration of the calibration gas is configured to be substantially equal to a monitoring span value without calibration gas pressurization.

5. The system of claim 1, wherein the light source is at least one of a UV or IR light source.

6. The system of claim 1, further comprising one or more additional light sources for scanning different wavelengths.

7. The system of claim 1, wherein a light-source alignment is fine-tuned using a pitch-yaw controlled flat mirror and a telescope mounted on a linear stage.

8. The system of claim 1, wherein the pathlength of the calibration gas cell for in situ continuous emissions measurement system complies with Performance Specifications 2 and 18 under 40 CFR Part 60.

9. The system of claim 1, wherein the gas emissions are analyzed to determine the concentration of at least one of BTX, Cl₂, CH₄, CO, CO₂, CS₂, HCHO, HCl, HCN, HF, H₂O, H₂S, NH₃, NO, NO₂, O₂, or SO₂.

10. The system of claim 1, wherein the analyzer is a pre-calibrated, continuous multi-gas analyzer.

11. The system of claim 1, wherein the spectrometer is self-stabilized via monitoring and compensating for intensity variations of the light source.

12. The system of claim 1, wherein the spectrometer can analyze multiple gases for each scanning laser.

13. The system of claim 1, further comprising two input gas ports disposed on opposing sides of the calibration gas cell along its length and an output extractive gas port disposed at one end of the calibration gas cell.

14. A system for analyzing gas emissions in situ comprising:
a broadband UV light source,
a first optical element that collimates the broadband UV light into a collimated UV light beam,
a first light transmission window on a first side of an emissions stack through which the collimated UV light beam enters the emissions stack,
a second light transmission window on a second side of the emissions stack through which the collimated UV light beam exits the emissions stack,
a second optical element that collects and focuses the exiting collimated UV light source unto a fiber optic connected to a flow-through, multiple-pass calibration gas cell,
wherein one or more gases in the emissions stack and the calibration gas cell undergo UV light absorption,
an absorbance due to absorption of UV light by a calibration gas in the calibration gas cell is added to the absorbance due to the absorption of UV light by the one or more gases in the emissions stack; and
the UV light beam that exits the calibration gas cell is directed to a spectrometer for analysis.

15. A system for analyzing gas emissions in situ comprising:
a narrowband IR light source located in a rack-mounted analyzer box for digitizing and processing an analog signal received by the detector,
a fiber optic coupled to a flow-through, multi-pass calibration gas cell,
an optical element on a second side of the emissions stack collects light transmitted from the emissions stack and directs the collected light to a detector,
wherein
a flow-through gas cell output fiber optic is connected to a free-space injection optical assembly located on a first side of an emissions stack;
a narrowband IR light source beam that exits the calibration gas cell and propagates through the output fiber optic is injected across the emissions stack, and
an absorbance due to absorption of light from the narrowband IR light source by a calibration gas in the calibration gas cell is added the absorbance due to the absorption of light from the narrowband IR light source by one or more gases in the emissions stack,
light-source alignment is fine-tuned using a telescope positioned on a linear stage for focusing and a pitch-yaw controlled flat mirror, and
the calibration gas cell is located in a launcher box.

16. A method for analyzing gas emissions in situ comprising:
directing a light beam from a light source to a first light transmission window on a first side of an emissions stack, wherein the light beam exits through a second light transmission window on a second side of the emissions stack after traversing the entire length of the emissions stack,
focusing the light beam into a multi-pass calibration gas cell containing a calibration gas and within which the light beam propagates multiple times across a length spanned by a first calibration gas cell window and a second calibration gas cell window,
receiving by a detector a transmitted optical signal from the emissions stack or calibration gas cell,
measuring one or more properties of at least one gas from the emissions stack via a spectrometer,
wherein
the spectrometer is a component of an analyzer coupled to a computing device,
the at least one gas from the emissions stack is sampled across an entire length of the emissions stack,
a concentration of the calibration gas that flows through the calibration gas cell is configured to be close or equal to a monitoring span value, and
a flow-through, gas-cell input fiber optic is connected to a free-space injection optical assembly located on the first side of the emissions stack.
